(19) United States
(12) Patent Application Publication
(10) Pub. No.: US 2005/0157819 A1
(43) Pub. Date: Jul. 21, 2005

(54) Receivers gain imbalance calibration circuits and methods thereof

(75) Inventors: Chung-Cheng Wang, Xizhi City (TW); John-San Yang, Kaohsiung City (TW); Yu-Hua Liu, Beipu Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Airoha Technology Corp.

(21) Appl. No.: 11/037,912

(22) Filed: Jan. 18, 2005

(30) Foreign Application Priority Data
Jan. 19, 2004 (TW) 93101339

(51) Int. Cl. H04L 5/12

(52) U.S. Cl. 375/322

(57) ABSTRACT

A receiver comprising an in-phase channel circuit, a quadrature channel circuit, and a gain imbalance calibration circuit comprising a first circuit and a second circuit. The first circuit provides testing signals to the in-phase channel circuit and the quadrature channel circuit. Test resultant signals output from the in-phase channel circuit and the quadrature channel circuit are input to the second circuit. The second circuit calibrates the gain of baseband amplifiers of the in-phase channel and the quadrature channel circuit according to the offset between the test resultant signals, thereby enabling the test resultant signal of the in-phase channel circuit to be substantially equal to the test resultant signal of the quadrature channel circuit.

### BACKGROUND

The present invention relates to a gain imbalance calibration circuit, and more particularly to a gain imbalance calibration circuit applied in a quadrature receiver.

FIG. 1 shows a conventional quadrature receiver. A set of complex communication signals 101 is input to a mixer 103, 104, and each is mixed with a sine signal having 90 degree offset for respective conversion to an in-phase signal 111 and a quadrature signal 112. The in-phase signal 111 and the quadrature signal 112 are filtered by channel filters 105 and 106 and then processed by a baseband amplifiers 107 and 108 to produce a baseband in-phase signal 109 and a baseband quadrature signal 110, respectively.

In an ideal situation, the amplitudes of the baseband in-phase signal 109 and the baseband quadrature signal 110 are the same because a set of internal circuit schemes of the channel filter 105 and baseband amplifier 107 are the same as a set of the channel filter 106 and baseband amplifier 108. Offset of the electrical signal, however, results from process variation during manufacture or temperature influence, thus producing in-phase/quadrature (I/Q) gain imbalance. I/Q gain imbalances increase bit error rate (BER) and degrade receiver performance in communication system such as GSM or WLAN.

### SUMMARY

Receivers are provided. An exemplary embodiment of a receiver comprises an in-phase channel circuit, a quadrature channel circuit, and a gain imbalance calibration circuit comprising a first circuit and a second circuit. The first circuit is coupled to demodulation ends of the in-phase channel circuit and the quadrature channel circuit, providing testing signals thereto respectively. Test resultant signals output from the in-phase channel circuit and the quadrature channel circuit are input to the second circuit comprising an offset calculation unit to calibrate the gain of baseband amplifiers of the in-phase channel and the quadrature channel circuit according to the offset between the test resultant signals, to enable the test resultant signal of the in-phase channel circuit to be substantially equal to the test resultant signal of the quadrature channel circuit.

### BRIEF DESCRIPTION OF THE DRAWINGS

The invention will become more fully understood from the detailed description given herein below and the accompanying drawings, given by way of illustration only and thus not intended to be limitative of the invention.

FIG. 1 shows a conventional quadrature receiver.

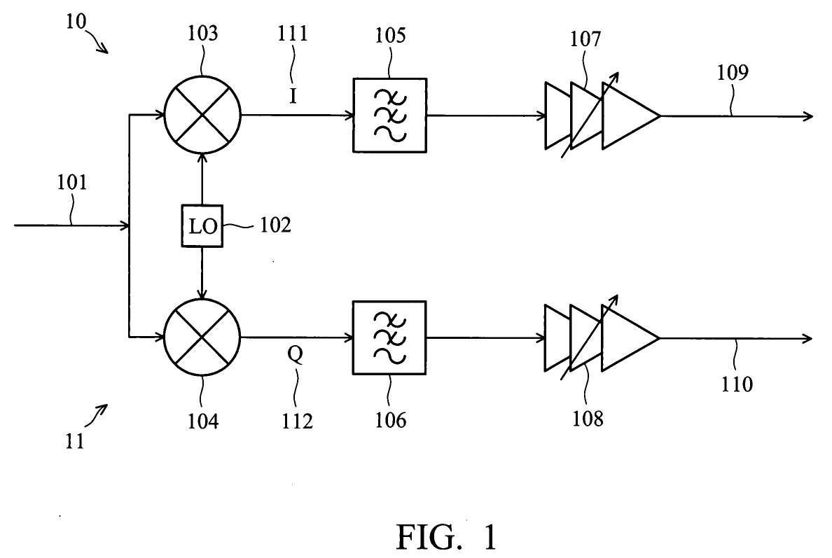

FIG. 2 shows an embodiment of a receiver.

FIG. 3 shows a first circuit and a second circuit in detail.

FIG. 4 shows a baseband amplifier in detail.

FIG. 5 is a flowchart of an embodiment of a gain imbalance calibration method.

FIG. 6 is a detailed flowchart of step S3 of FIG. 5.

### DETAILED DESCRIPTION

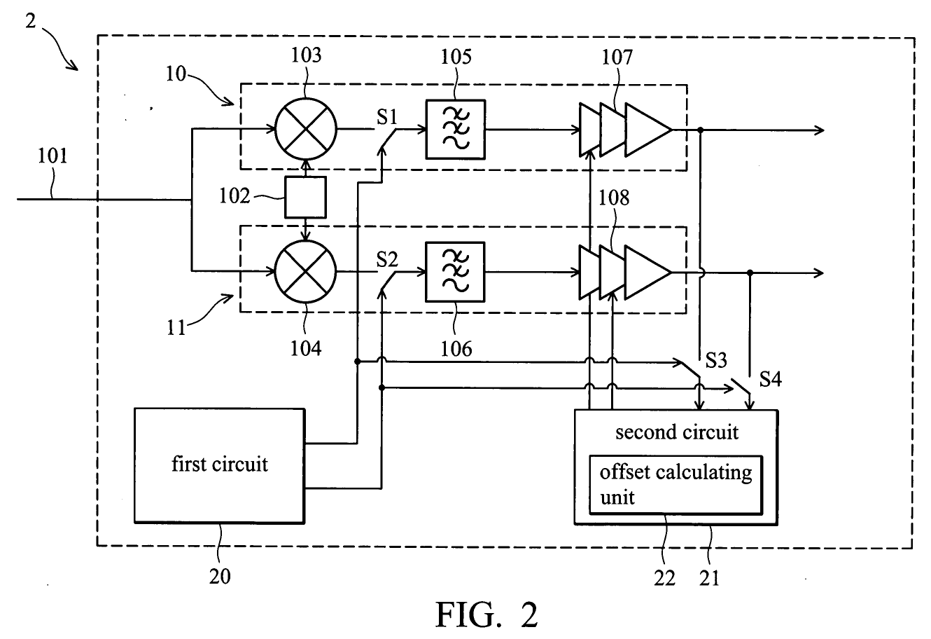

Receivers are provided. In some embodiments, as shown in FIG. 2, the receiver 2 comprises an in-phase channel circuit 10, a quadrature channel circuit 11, a first circuit 20, and a second circuit 21.

The in-phase channel circuit 10 includes a mixer 103, a channel filter 105, and a baseband amplifier 107. The mixer 103 has an input receiving a complex communication signal 101 in a receiving state. The complex communication signal 101 is mixed with an in-phase channel signal generated by the local oscillator 102. The channel filter 105 is coupled to the output of the mixer 103 through switch S1 (first switch). The baseband amplifier 107 is coupled to the output of the channel filter 105. Similarly, the quadrature channel circuit 11 includes a mixer 104, a channel filter 106, and a baseband amplifier 108. The mixer 104 has an input receiving a complex communication signal 101 in a receiving state. The complex communication signal 101 is mixed with a quadrature channel signal generated by the local oscillator 102. The channel filter 106 is coupled to the output of the mixer 104 through switch S2 (second switch). The baseband amplifier 108 is coupled to the output of the channel filter 106.

The first circuit 20 is coupled to demodulation ends of the in-phase channel circuit 10 and the quadrature channel circuit 11, providing testing signals to the in-phase channel circuit 10 and the quadrature channel circuit 11 respectively.

The second circuit 21 receives testing resultant signals respectively output from the in-phase channel circuit 10 and the quadrature channel circuit 11 and comprises an offset calculation unit 22. The offset calculation unit 22 calibrates the gains of the baseband amplifiers 107 and 108 according to the offset between the two testing signals from the in-phase channel circuit 10 and the quadrature channel circuit 11, to enable the test signal of the in-phase channel circuit 10 to be substantially equal to the test signal of the quadrature channel circuit 11.

In practice, while gain compensation is implemented, switches S1 and S2 are switched to the output of the first circuit 20. The first circuit outputs testing signals provided to the in-phase channel circuit 10 and the quadrature channel circuit 11. In the in-phase channel circuit 10, after the testing signal is filtered by the channel filter 105 and then amplified by the baseband amplifier 107, a test resultant signal is output. In the quadrature channel circuit 11, after the testing signal is filtered by the channel filter 106 and amplified by the baseband amplifier 108, the other test resultant signal is output. The test resultant signals are input to the offset calculating unit 22 of the second circuit 21 to calculate the offset between the two test resultant signals. The offset calculating unit 22 adjusts the gain of the baseband amplifiers 107 and 108 according to the offset between the two test resultant signals, to enable the test resultant signal of the in-phase channel circuit 10 to be substantially equal to the test resultant signal of the quadrature channel circuit 11. After calibration, normal receiving function is implemented, and the gain of the amplifier is calibrated, resulting in better performance of the receiver 2.

Receiver 2 further has a switch S3 between the output of the baseband amplifier 107 and the second circuit 21 and a switch S4 between the output of the baseband amplifier 108 and the second circuit 21. The switch S3 the switch S4 are switched selectively to couple the second circuit 21 to the baseband amplifiers 107 and 108 or the first circuit 20 to perform calibration of the first circuit 20.

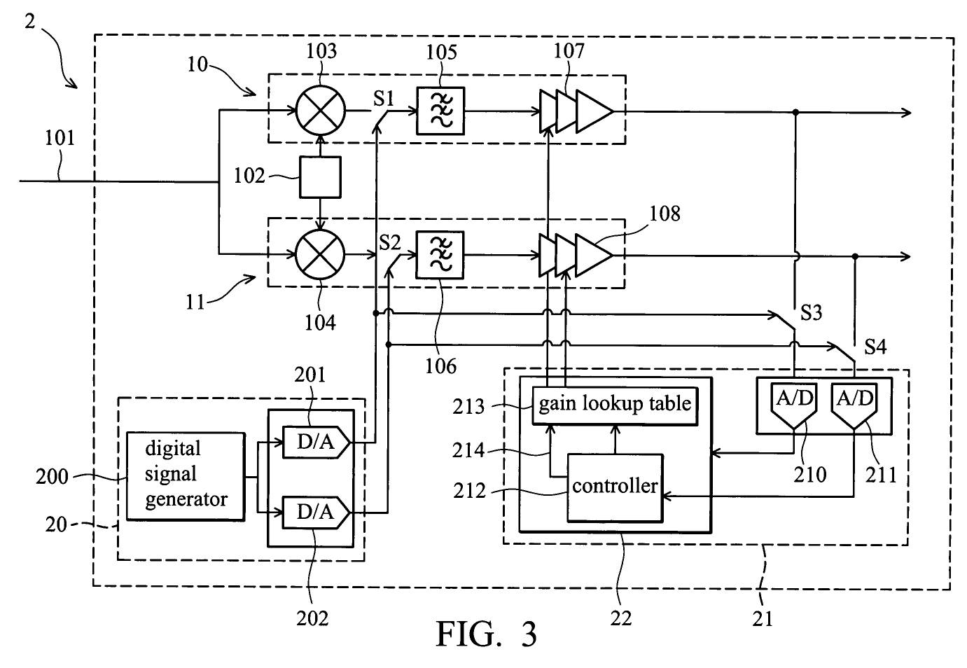

Receivers are provided. In some embodiments, as shown in FIG. 3, schemes of the in-phase channel circuit 10 and the quadrature circuit 11 are the same thus description is omitted here. FIG. 3 shows detailed circuits of the first circuit 20 and the second circuit 21.

The first circuit 20 includes a digital signal generator 200, a first digital/analog converter 201 and a second digital/analog converter 202. The digital signal generator 200 generates the testing signals, such as digital signals in a sine wave. The input of the first digital/analog converter 201 is coupled to the digital signal generator 200 to receive one testing signal. The output of the first digital/analog converter 201 is coupled to the switch S1 of the in-phase channel circuit 10. The input of the second digital/analog converter 202 is coupled to the digital signal generator 200, receiving the other testing signal. The output of the second digital/analog circuit 202 is coupled to the switch S2 of the quadrature channel circuit 11.

The second circuit 21 comprises a first analog/digital converter 210, a second analog/digital converter 211 and an offset calculating unit 22. The input of the first analog/digital converter 210 is coupled to the output of the baseband amplifier 107 to receive a test resultant signal and converts the test resultant signal to a corresponding first digital signal. The input of the second analog/digital converter 211 is coupled to the output of the baseband amplifier 108 to receive the test resultant signal and converts test resultant signal to a second digital signal.

In practice, before calibration, a controller 212 of the offset calculating unit 22 detects all possible gains of the baseband amplifiers 108 and calculates all offsets under corresponding gains. The controller 212 stores the offsets in a gain lookup table 213. When compensation proceeds, the digital generator 200 generates a set of digital testing signals and transmits the digital testing signals to the first digital/analog converter 201 and the second digital/analog converter 202. The digital/analog converters 201 and 212 convert the digital testing signals to corresponding analog testing signals and output them to the in-phase channel circuit 10 and the quadrature channel circuit 11 through switches S1 and S2, respectively. After one digital testing signal is filtered by the channel filter 105 and amplified by the baseband amplifier 107, one test resultant signal is output from the in-phase channel circuit 10. After the other digital testing signal is filtered by the channel filter 106 and amplified by the baseband amplifier 108, the other test resultant signal is output from the quadrature channel circuit 11. The two test resultant signals are converted by the analog/digital converters 210 and 211 to first and second digital signals, respectively. The controller 212 calculates an offset value according to the first and second digital signals. The controller 212 outputs the offset value to the gain lookup table 213 to locate the corresponding gain. The baseband amplifiers 107 and 108 are then adjusted by the offset calculating unit 22.

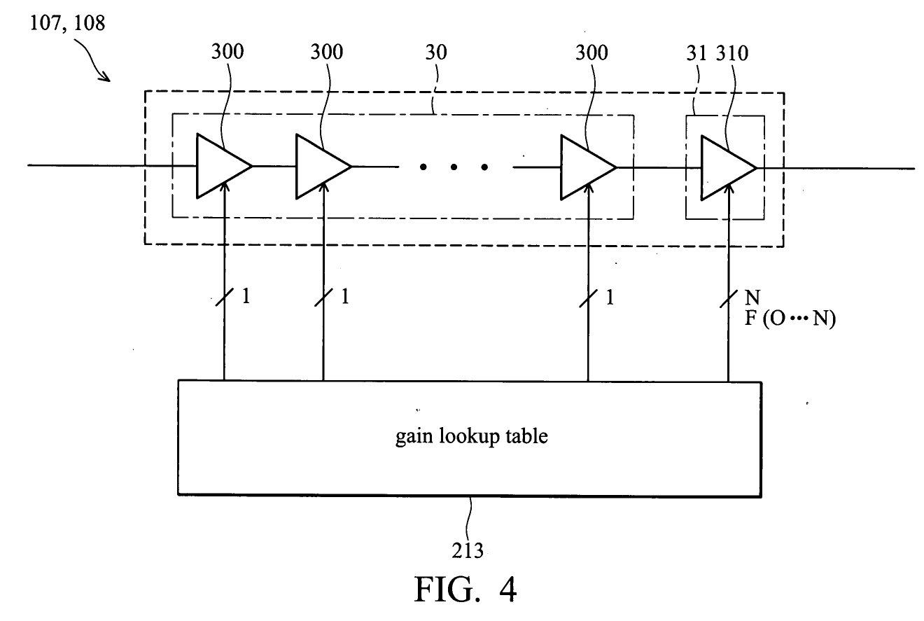

Detailed description of the adjustment is shown in FIG. 4. The baseband amplifier 107 is used as an example. The baseband amplifier 107 comprises a rough-tuning amplifying stage 30 and a fine-tuning amplifying stage 31. The rough-tuning amplifying stage 30 comprises a plurality of amplifiers 300 connected in cascade, each amplifier 300 turned on or off by a control bit. The fine-tuning amplifying stage 31 comprises an amplifier 310 controlled by the Nth bit control signal.

When a set of control words are output from the gain look up table 213, the amplifiers 300 and 310 are turned on or off correspondingly, and a signal is finally output according to the sum of the total gain by the amplifiers 300 and 310 connected in cascade.

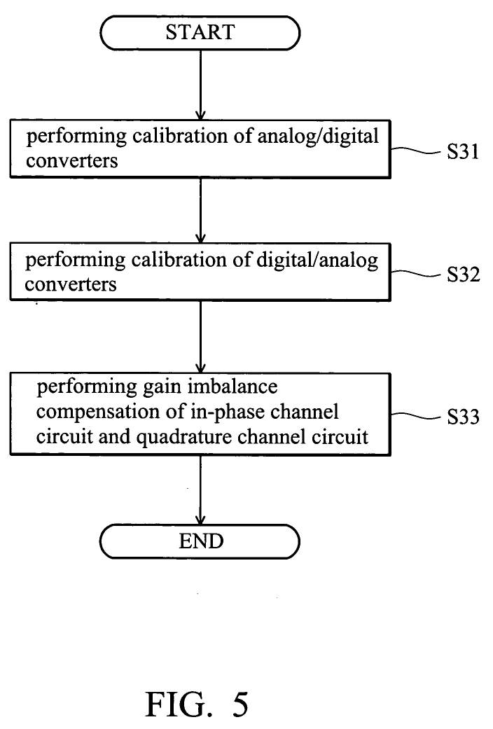

Gain imbalance calibration methods are provided. In some embodiments, as shown in FIG. 5, a method is applied in the gain imbalance calibration circuits shown in FIG. 2 and FIG. 3.

Calibration of the analog/digital converter is performed in step S31. First, the first and the second analog/digital converters are coupled to a reference voltage, such as ground, so that a DC current signal is input to the first and second analog/digital converters for conversion to corresponding digital signals. Next, a first offset value is calculated by the offset calculating unit according to the two digital signals and then recorded by the controller.

Calibration of the digital/analog converter is performed in step S32. First, the switches S1 and S2 are switched to couple the outputs of the first and second digital/analog converters respectively to the inputs of the first and second analog/digital converters. Next, one testing signal is generated from the digital signal generator and converted to a corresponding digital signal through the first digital/analog and analog/digital converters. The other testing signal is generated from the digital signal generator and converted to a corresponding digital signal through the second digital/analog and analog/digital converters. Respective digital signals from the first and second analog/digital converters are input to the offset calculating unit to calculate the offset value. The controller subtracts the first offset value and generates a second offset value. The second offset value is recoded.

A gain imbalance calibration of in-phase channel circuit and quadrature channel circuit is performed in step S3. The first and second digital/analog converters are coupled to the outputs of the two mixers. The digital generator generates digital testing signals and respectively transmits them through two digital/analog converters, the in-phase channel circuit and the quadrature channel circuit, and two analog/digital converters to the controller of the offset calculating unit. The controller calculates the offset value (the third offset value) After subtracting the first offset value and the second offset value from the third offset value, the controller calculates the correct offset value (fourth offset value) of the in-phase channel circuit and the quadrature channel circuit. The gain of the baseband amplifier of the in-phase channel circuit and the quadrature channel circuit is adjusted according to the correct offset value to enable the test resultant signal of the in-phase channel circuit substantially equal to the test signal of the quadrature channel circuit.

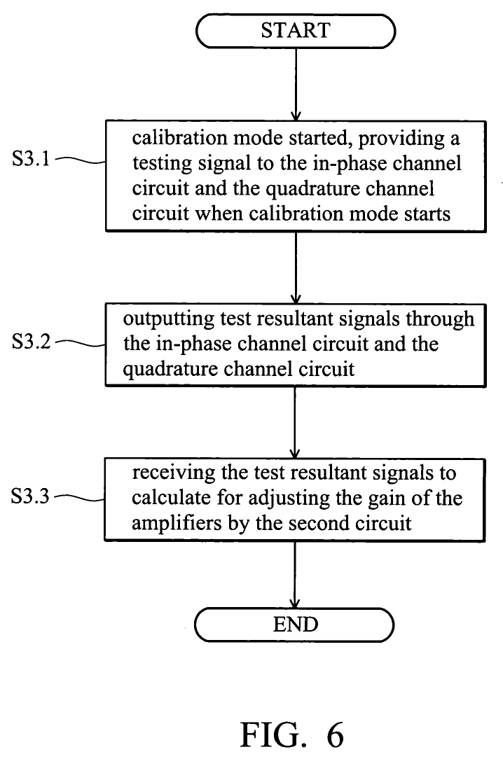

FIG. 6 is a detailed flowchart of step S3. In step S3.1, calibration mode is implemented. Switches S1 and S2 are connected to the output of the first circuit, and the first circuit generates a set of testing signals and outputs them to the in-phase channel circuit and the quadrature channel circuit respectively.

Next, in step S3.2, test resultant signals are output after the testing signals are proceeded by the in-phase channel circuit and quadrature channel circuit.

Finally, in step S3.3, the test resultant signals are input to the second circuit, and the offset calculating unit calculates the third offset value.

While the invention has been described in terms of preferred embodiment, it is to be understood that the invention is not limited thereto. On the contrary, it is intended to cover various modifications and similar arrangements as would be apparent to those skilled in the art. Therefore, the scope of the appended claims should be accorded the broadest interpretation so as to encompass all such modifications and similar arrangements.

1. A receiver, comprising:
an in-phase channel circuit;
a quadrature channel circuit; and
a gain imbalance calibration circuit, comprising:
a first circuit coupled to demodulation ends of the in-phase channel circuit and the quadrature channel circuit, providing testing signals respectively to the in-phase channel circuit and the quadrature channel circuit; and
a second circuit receiving test resultant signals output respectively from the in-phase channel circuit and the quadrature channel circuit, and comprising an offset calculation unit to calibrate the gains of baseband amplifiers of the in-phase channel and the quadrature channel circuit according to an offset value from the two test resultant signals thereof to enable the test resultant signal of the in-phase channel circuit to be substantially equal to the test resultant signal of the quadrature channel circuit.

2. The receiver as claimed in claim 1, wherein the in-phase channel circuit comprises:
a first mixer;
a first channel filter coupled to an output of the mixer; and
a first baseband amplifier coupled to an output of the channel filter; and
the quadrature channel circuit comprises:
a second mixer;
a second channel filter coupled to an output of the mixer; and
a second baseband amplifier coupled to an output of the channel filter.

3. The receiver as claimed in claim 2, wherein the first circuit comprises a digital signal generator to generate the testing signals.

4. The receiver as claimed in claim 3, wherein the first circuit further comprises:
a first digital/analog converter comprising an first input end coupled to the digital signal generator and an first output end coupled to the output of the mixer of the in-phase channel circuit; and
a second digital/analog converter comprising an second input end coupled to the digital signal generator and an second output end coupled to the output of the mixer of the quadrature channel circuit.

5. The receiver as claimed in claim 4, further comprising:
a first switch disposed between the mixer and the channel filter of the in-phase channel circuit and switched an input of the channel filter selectively coupling to the mixer and the first digital/analog converter; and
a second switch disposed between the mixer and the channel filter of the quadrature circuit and switched selectively coupling an input of the channel filter to the mixer and the second digital/analog converter.

6. The receiver as claimed in claim 5, wherein the second circuit comprises:
a first analog/digital converter coupled to an output of the baseband amplifier of the in-phase channel circuit and receiving a test resultant signal output from the in-phase channel circuit to convert the test resultant signal to a first digital signal; and
a second analog/digital converter coupled to an output of the baseband amplifier of the quadrature channel circuit and receiving a test resultant signal output from the quadrature channel circuit to convert the test resultant signal to a second digital signal.

7. The receiver as claimed in claim 6, wherein the offset calculating unit comprising:
a controller receiving the first digital signal and the second digital signal and calculating an offset value; and
a gain lookup table searched by the controller to output a gain corresponding to the offset value.

8. The receiver as claimed in claim 6, wherein the output of the first digital/analog converter is coupled to an input end of the first analog/digital converter, and the output end of the second digital/analog converter is coupled to an input end of the second analog/digital converter.

9. The receiver as claimed in claim 8, further comprising: a third switch disposed between the output of the baseband amplifier of the in-phase channel circuit and the first analog/digital converter and switched selectively to coupled the first analog/digital converter to the baseband amplifier or the first digital/analog converter; and
a fourth switch disposed between the output of the baseband amplifier of the quadrature channel circuit and the second analog/digital converter and switched selectively to coupled the second analog/digital converter to the baseband amplifier or the second digital/analog converter.

10. The receiver as claimed in claim 2, wherein each baseband amplifier further comprises a rough-tuning amplifying stage and a fine-tuning amplifying stage.

11. The receiver as claimed in claim 10, wherein the rough-tuning amplifying stage comprises a plurality of amplifiers connected in cascade and each amplifier is turned on or off by a control bit signal.

12. The receiver as claimed in claim 10, wherein the fine-tuning amplifying stage comprises an amplifier turned on or off by n control bit signals.

13. A gain imbalance calibration circuit applied in a receiver comprising an in-phase channel circuit and a quadrature channel circuit, comprising:
a first circuit coupled to demodulation ends of the in-phase channel circuit and the quadrature channel circuit, providing testing signals respectively to the in-phase channel circuit and the quadrature channel circuit; and
a second circuit receiving test resultant signals output respectively from the in-phase channel circuit and the quadrature channel circuit and comprising an offset calculation unit to calibrate the gains of baseband amplifiers of the in-phase channel and the quadrature channel circuit according to an offset value from the two test resultant signals thereof to enable the test resultant signal of the in-phase channel circuit to be substantially equal to the test resultant signal of the quadrature channel circuit.

14. The gain imbalance calibration circuit as claimed in claim 13, wherein the in phase channel circuit comprises:
a mixer;
a channel filter coupled to an output of the mixer; and
a baseband amplifier coupled to an output of the channel filter; and
the quadrature channel circuit comprises:
a mixer;
a channel filter coupled to an output of the mixer; and
a baseband amplifier coupled to an output of the channel filter.

15. A gain imbalance calibration method for a receiver comprising an in-phase channel circuit, a quadrature channel circuit, and a gain imbalance calibration circuit comprising a first circuit and a second circuit, the gain imbalance calibration method comprising the following steps:
a. providing testing signals by the first circuit respectively to the in-phase channel circuit and the quadrature channel circuit in a calibration mode;
b. outputting test resultant signals respectively by the in-phase channel circuit and the quadrature channel circuit;
c. adjusting the gain of baseband amplifiers of the in-phase channel circuit and the quadrature channel circuit by an offset calculating unit according to the test resultant signals thereby enabling the test resultant signal of the in-phase channel to be substantially equal to the test resultant signal of the quadrature channel.

16. The gain imbalance calibration method as claimed in claim 15, further comprising:
a.1. performing calibration of analog/digital converters, calculating the offset between a first analog/digital converter and a second analog/digital converter of the second circuit, and generating a first offset value; and
a.2. performing calibration of digital/analog converters, calculating the offset between a first digital/analog converter and a second digital/analog converter of the first circuit, and generating a second offset value.

17. The gain imbalance calibration method as claimed in claim 16, wherein step (c) comprises:
obtaining a main offset value by the second circuit according to the test resultant signals; and
subtracting the first offset value and the second offset value from the main offset value and obtaining a correct offset value of the in-phase channel circuit and the quadrature channel circuit.

18. The gain imbalance calibration method as claimed in claim 17, wherein the main offset value is a third offset value, the correct offset value is a fourth offset value, and step (c) comprises:
providing testing signals to the first digital/analog converter and the second digital/analog converter for conversion;
passing the testing signals through the in-phase channel circuit and the quadrature channel circuit;
outputting digital signals by the in-phase channel circuit and the quadrature channel circuit to the second circuit; and
generating the fourth offset value after subtracting the first offset value and the second offset value from the third offset value.

19. The gain imbalance calibration method as claimed in claim 16, wherein step (a.1) comprises:
providing a DC current signal to the first analog/digital converter and the second analog/digital converter;
outputting corresponding digital signals by the first analog/digital converter and the second analog/digital converter; and
calculating the first offset value according to the two digital signals by the offset calculating unit.

20. The gain imbalance calibration method as claimed in claim 16, wherein step (a.2) comprises:
generating testing signals; and
generating corresponding digital signals according to the testing signals transmitted through the first digital/analog converter, the second digital/analog converter, the first analog/digital converter, and the second analog/digital converter;
calculating the second offset value according to the digital signals.
